(19) United States
(12) Patent Application Publication
(10) Pub. No.: US 2016/0148359 A1
(43) Pub. Date: May 26, 2016

(54) Fast Computation of a Laplacian Pyramid in a Parallel Computing Environment

(71) Applicant: Siemens Medical Solutions USA, Inc., Malvern, PA (US)

(72) Inventor: Marianna Gnedin, Long Grove, IL (US)

(21) Appl. No.: 14/548,520

(22) Filed: Nov. 20, 2014

(51) Int. Cl. G06T 5/20; G06T 5/00

(52) U.S. Cl. CPC G06T 5/20; G06T 5/002; G06T 2207/20182

(57) ABSTRACT

A computer-implemented method for calculating a Laplacian pyramid in an image processing system comprising a parallel computing platform includes constructing a first layer of a Gaussian pyramid based on an original image. A plurality of Laplacian pyramid layers are constructed using a plurality of device kernels executing on a graphical processing device included in the parallel computing platform. Each respective Laplacian pyramid layer is constructed by a process which includes using one or more first device kernels to calculate a Gaussian pyramid layer based on a immediately preceding Gaussian pyramid layer and using one or more second device kernels to calculate the respective Laplacian pyramid layer based on the immediately preceding Gaussian pyramid layer in parallel with calculation of the Gaussian pyramid layer.

### TECHNOLOGY FIELD

The present invention relates generally to methods, systems, and apparatuses for calculating a Laplacian pyramid in a computing environment where operations related to computing individual pyramid layers may be performed in parallel. The disclosed methods, systems, and apparatuses may be used in, for example, various medical imaging applications.

### BACKGROUND

An image pyramid is a type of multi-scale signal representation in which an image is subjected to repeated smoothing and subsampling. There are several different types of image pyramids known in art. For example, with a Gaussian pyramid, each layer is a low pass, Gaussian filtered and downsampled version of the previous layer. Downsampling is performed by removing (or otherwise ignoring) every second row and column in the image data. Upsampling may be performed with another type of pyramid, referred to as a Laplacian pyramid. The Laplacian pyramid layers, except for the coarsest one and the zero layer (i.e., the difference between the upsampled coarser layer and the initial image), store the difference between the upsampled coarser layer and the corresponding layer of the Gaussian pyramid. The coarsest layer in the Laplacian pyramid is the low-pass image, same as in the Gaussian pyramid. To build the i-th layer of the Laplacian pyramid, the next, smaller, i+1 layer of the Gaussian pyramid is upsampled and filtered, then the difference between the i-th Gaussian pyramid layer and the upsampled and low pass filtered i+1 layer is computed. Upsampling is accomplished by adding zero rows and zero columns after each existing row and column. Then, the upsampled image may be convolved with a Gaussian filter.

The Laplacian pyramid decomposition of an image is a common starting point in many multi-scale imaging algorithms in the areas such as image enhancement, coding, stitching, and restoration. Since its implementation is time consuming and involves expensive convolutions and upsampling/downsampling steps, it can easily become the bottleneck of the whole image processing application. Therefore, it would be desirable to reduce the time required for performing Laplacian pyramid calculations such that the overall processing time of the imaging processing application can be minimized.

### SUMMARY

Embodiments of the present invention address and overcome one or more of the above shortcomings and drawbacks, by providing methods, systems, and apparatuses which calculate a Laplacian pyramid using a parallel computing platform. Briefly, the operations associated with pyramid layer are performed in parallel and certain operations may be combined to minimize memory access requirements. This technology may be applied to various image processing applications. For example, for medical fluoroscopy procedures, the technology described herein may be applied to reduce the time required to process acquired images.

According to some embodiments, a first computer-implemented method for calculating a Laplacian pyramid in an image processing system comprising a parallel computing platform includes constructing a first layer of a Gaussian pyramid based on an original image. A plurality of Laplacian pyramid layers are constructed using a plurality of device kernels executing on a graphical processing device included in the parallel computing platform. Each respective Laplacian pyramid layer is constructed by a process implemented by one or more first device kernels and one or more second device kernels. The first device kernels are used to calculate a Gaussian pyramid layer based on an immediately preceding Gaussian pyramid layer. The second device kernels are used to calculate the respective Laplacian pyramid layer based on the immediately preceding Gaussian pyramid layer in parallel with calculation of the Gaussian pyramid layer. In one embodiment, two or more of the plurality of Laplacian pyramid layers may be calculated in parallel using the parallel computing platform.

In some embodiments of the aforementioned first method for calculating a Laplacian pyramid, each respective Gaussian pyramid layer is calculated using a single operation on a respective computation unit. The single operation combines upsampling the immediately preceding Gaussian pyramid layer to yield an upsampled layer and convolving the upsampled layer with a Gaussian filter to yield the Gaussian pyramid layer. In some embodiments, the single operation further comprises downsampling the Gaussian pyramid layer. In some embodiments, convolving the upsampled layer with the Gaussian filter to yield the Gaussian pyramid layer includes computing a plurality of horizontal convolutions using a horizontal filter and the upsampled layer and computing a plurality of vertical convolutions using a vertical filter and the upsampled layer. In one embodiment, the horizontal convolutions and the vertical convolutions are computed in separate device kernels included in the one or more first device kernels.

In some embodiments of the aforementioned first method for calculating a Laplacian pyramid, each respective Laplacian pyramid layer is calculated using a single operation on a respective computation unit. In this context, the single operation includes the steps of upsampling the immediately preceding Gaussian pyramid layer to yield a upsampled layer; smoothing the upsampled layer to yield a smoothed upsampled layer; and subtracting the smoothed upsampled layer from the original image or from a corresponding layer of the Gaussian pyramid to yield the respective Laplacian pyramid layer. In one embodiment, smoothing the upsampled layer to yield the smoothed upsampled layer includes the steps of computing a plurality of horizontal convolutions uses a horizontal filter and the upsampled layer and computing a plurality of vertical convolutions uses a vertical filter and the upsampled layer. The horizontal convolutions and the vertical convolutions may be computed in separate device kernels included in the one or more second device kernels.

According to other embodiments, a second computer-implemented method for calculating a Laplacian pyramid in an image processing system comprising a host computing unit and a graphical processing device includes copying an original image from a host memory at the host computing unit to a portion of device memory on the graphical processing device and constructing a first layer of a Gaussian pyramid based on the original image. A plurality of device kernels is executed on the graphical processing device to calculate the Laplacian pyramid. Each respective layer in the Laplacian pyramid is calculated using a set of device kernels. One or more first kernels in the set are configured to calculate a Gaussian pyramid layer based on an immediately preceding Gaussian pyramid layer. One or more second kernels in the set are configured to calculate a respective Laplacian pyramid layer based on the immediately preceding Gaussian pyramid layer. After the Laplacian pyramid is calculated, it is copied from the portion of device memory on the graphical processing device to the host memory.

Various additional features and/or enhancements may be added to the aforementioned second computer-implemented method for calculating a Laplacian pyramid. For example, in some embodiments, prior copying the original image to the portion of device memory, the portion of device memory on the graphical processing device is allocated based on a size of the original image. After executing the plurality of device kernels, the portion of device memory is deallocated. In some embodiments, the set of device kernels described in the method is executed in parallel on the graphical processing device. In some embodiments, the first layer of the Gaussian pyramid is constructed at the graphical processing device using a third kernel configured to calculate the first layer of the Gaussian pyramid based on the original image. In some embodiments, each respective device kernel in the plurality of device kernels is executed independently by a distinct grid of thread blocks on the graphical processing device. In some embodiments, a plurality of second kernels is configured in parallel to calculate a plurality of Laplacian pyramid layers.

Similar to the first computer-implemented method for calculating a Laplacian pyramid described above, in some embodiments of the second method, each respective first kernel is configured to calculate the Gaussian pyramid layer based on the immediately preceding Gaussian pyramid layer using a single operation which combines upsampling the immediately preceding Gaussian pyramid layer, convolving the upsampled layer with a Gaussian filter to yield the Gaussian pyramid layer, and downsampling the Gaussian pyramid layer. Also, in some embodiments, each respective second kernel is configured to calculate the respective Laplacian pyramid layer using a single operation which combines upsampling the immediately preceding Gaussian pyramid layer, smoothing the upsampled layer to yield a smoothed upsampled layer; and subtracting the smoothed upsampled layer from the original image to yield the respective Laplacian pyramid layer.

In other embodiments, a system for calculating a Laplacian pyramid includes a processor and a graphical processing device. The processor is configured to construct a first layer of a Gaussian pyramid based on an original image. The graphical processing device is configured to execute a plurality of device kernels to calculate the Laplacian pyramid. Each respective Laplacian pyramid layer is calculated using a set of device kernels. One or more first device kernels in the set are configured to calculate a Gaussian pyramid layer based on an immediately preceding Gaussian pyramid layer. One or more second device kernels in the set are configured to calculate the respective Laplacian pyramid layer based on the immediately preceding Gaussian pyramid layer.

In one embodiment of the aforementioned system, each respective first device kernel is configured to calculate the Gaussian pyramid layer based on the immediately preceding Gaussian pyramid layer using a single operation which combines upsampling the immediately preceding Gaussian pyramid layer, convolving the upsampled layer with a Gaussian filter to yield the Gaussian pyramid layer, and downsampling the Gaussian pyramid layer. In another embodiment of the system, each respective second device kernel is configured to the respective Laplacian pyramid layer using a single operation which combines upsampling the immediately preceding Gaussian pyramid layer, smoothing the upsampled layer to yield a smoothed upsampled layer, and subtracting the smoothed upsampled layer from the original image to yield the respective Laplacian pyramid layer.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a system diagram of an imaging system, according to some embodiments of the present invention;

FIG. 2 provides an illustration of the parallel processing memory architecture that may be utilized by an image processing computer to perform computations related to a Laplacian pyramid, according to some embodiments of the present invention;

FIG. 3A provides an example of downsampling processing, according to some embodiments of the present invention;

FIG. 3B provides an example of upsampling processing, according to some embodiments of the present invention;

FIG. 4 provides an illustration of a method building a Laplacian pyramid with 4 layers, according to some embodiments of the present invention;

FIG. 5 provides a flowchart illustrating how images may be processed by an image processing computer utilizing a parallel computing platform, according to some embodiments of the present invention;

FIG. 6A shows an original image that may be acquired by an imaging device, according to some embodiments of the present invention;

FIG. 6B shows the imaging results of application of a Gaussian pyramid calculation process to the original image shown in FIG. 6A, according to some embodiments of the present invention;

FIG. 6C shows imaging results corresponding to the zero layer of a Laplacian pyramid, according to some embodiments of the present invention;

FIG. 6D shows imaging results corresponding to layer 1 through layer 5 of a Laplacian pyramid, according to some embodiments of the present invention; and

FIG. 7 illustrates an example of a computing environment within which embodiments of the invention may be implemented.

### DETAILED DESCRIPTION OF ILLUSTRATIVE EMBODIMENTS

The following disclosure describes the present invention according to several embodiments directed at performing fast computation of the Laplacian pyramid using a parallel computing platform and programming model such as the NVIDIA™ Compute Unified Device Architecture (CUDA). The techniques described herein are based, in part, on application of the principle of out-of-order execution to the computation of pyramid layers. Computation of the Laplacian layer i only utilizes one preexisting layer i+1 of the Gaussian pyramid (assuming that layer i has been acquired in advance). Thus, computation of other layers of the Laplacian pyramid may be performed at other, more convenient times. For example, in some embodiments of the present invention a respective Laplacian pyramid layer may be computed in parallel with computation of the next layer of the Gaussian pyramid. The two operations are expensive and approximately equal in length, which makes them ideal candidates for parallel execution, as described herein. The invention is applicable to various image processing applications including, but not limited to, image denoising and compression.

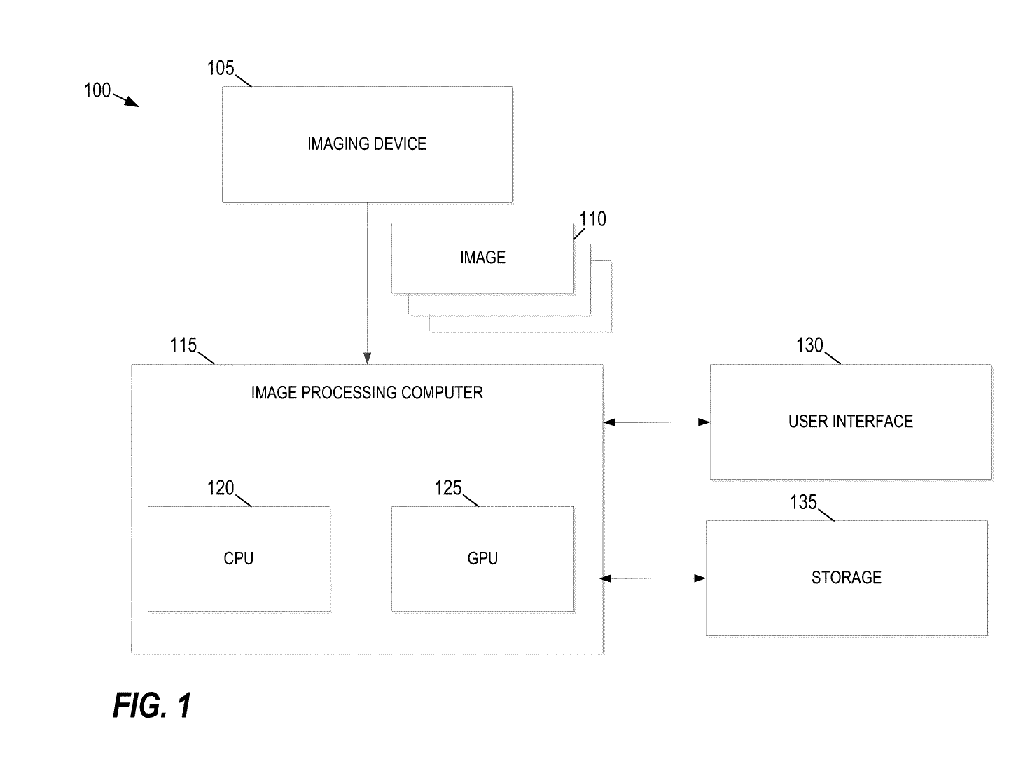

FIG. 1 is a system diagram of an imaging system 100, according to some embodiments of the present invention. An imaging device 105 transfers one or more images 110 to an image processing computer 115. In one embodiment, the imaging device 105 is a medical imaging device providing, for example, fluoroscopy imaging. However, it should be understood that the techniques described herein are generally applicable to any type of imaging device. In the example of FIG. 1, the image processing computer 115 includes one or more central processing units (CPUs) 120 and one or more graphics processing units (GPUs) 125. As is well understood in the art, the use of CPUs in combination with GPUs provides various computation advantages in engineering applications, including potentially reducing the time required to process computationally intense algorithms. The imaging device 105 and the image processing computer 115 may be connected directly or indirectly using any technique known in the art. Thus, for example, in some embodiments the imaging device 105 and the image processing computer 115 are directly connected using a proprietary cable or an industry standard cable such as a Universal Serial Bus (USB) cable. In other embodiments, the imaging device 105 and the image processing computer 115 are indirectly connected over one or more networks (not shown in FIG. 1). These networks may be wired, wireless or a combination thereof.

The imaging system 100 may include one or more computing units (not shown in FIG. 1). The term computing unit refers to any hardware and/or software configuration capable of executing a series of instructions. The computing unit can be defined in various levels of granularity. Thus, in some embodiments, the CPU is the computing unit while in other embodiments the processing cores within the CPU are the computing unit. In other embodiments, the computation unit is a thread block executed on a GPU. It should be noted that the number of computing units can scale based on the number of CPUs and/or GPUs available to the system 100. Thus, for example, if the imaging system 100 includes multiple imaging computers, each imaging computer may offer one or more computation units for use by the system 100.

Continuing with reference to FIG. 1, a user interface 130 is connected directly or indirectly to the image processing computer 115. The user interface 130 may include any interface known in the art including, for example and without limitation, a display, a keyboard, a mouse, and/or a touchscreen. Storage 135 is also connected, either directly or indirectly, to the image processing computer 115. In some embodiments, the image processing computer 115 may communicate with the storage 135 to retrieve images (not shown in FIG. 1) as an alternative to receiving images 110 from the imaging device 105. Storage 135 may be implemented using any technique known in the art and may utilize, for example, any combination of magnetic, semi-conductor, and/or optical storage media.

The present invention may be implemented across various computing architectures. In the example of FIG. 1, the invention is implemented on a single image processing computer 115 comprising both CPUs and GPUs. In some embodiments, calculations associated with a Laplacian pyramid, as described herein, may be performed using only CPUs or using a combination of CPUs and GPUs. In one embodiment, a parallel computing platform and programming model such as the NVIDIA™ Compute Unified Device Architecture (CUDA) may be used to optimize usage of the GPUs in computing the Laplacian pyramid. However, it should be noted that the imaging system 100 illustrated in FIG. 1 is merely one example of an imaging system that may be used to implement the present invention. In some embodiments, an imaging system includes multiple image processing computers directly or indirectly connected together in a cluster configuration.

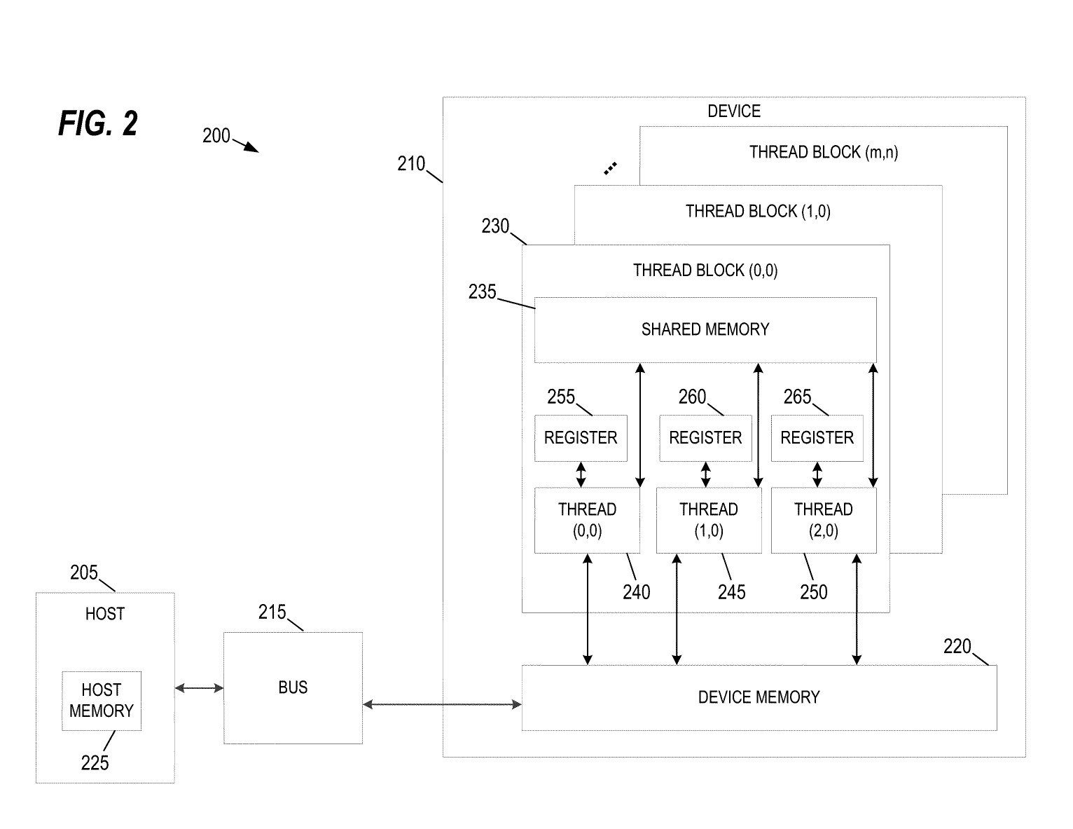

FIG. 2 provides an illustration of the parallel processing memory architecture 200 that may be utilized by an image processing computer (e.g., computer 115 in FIG. 1) to perform computations related to a Laplacian pyramid, according to some embodiments of the present invention. This architecture 200 may be used, for example, for implementations of the present invention where NVIDIA™ CUDA (or a similar parallel computing platform) is used. The architecture includes a host computing unit (“host”) 205 and a GPU device (“device”) 210 connected via a bus 215 (e.g., a PCIe bus). The host 205 includes the CPU (not shown in FIG. 2) and host memory 225 accessible to the CPU. The device 210 includes the GPU and its associated memory 220, referred to herein as device memory. The device memory 220 may include various types of memory, each optimized for different memory usages. For example, in some embodiments, the device memory includes global memory, constant memory, and texture memory.

Parallel portions of an application may be executed on the memory architecture 200 as “device kernels” or simply “kernels.” A kernel comprises parameterized code configured to perform a particular function. The parallel computing platform is configured to execute these kernels in an optimal manner across the memory architecture 200 based on parameters, settings, and other selections provided by the user. Additionally, in some embodiments, the parallel computing platform may include additional functionality to allow for automatic processing of kernels in an optimal manner with minimal input provided by the user.

The processing required for each kernel is performed by grid of thread blocks (described in greater detail below). Using concurrent kernel execution, streams, and synchronization with lightweight events, the memory architecture 200 of FIG. 2 (or similar architectures) may be used to parallelize the computation of Gaussian and Laplacian pyramid layers. For example, in one embodiment of the present invention there are two kernels that perform convolution and downsampling (one for a horizontal pass, one for a vertical pass over the image). Furthermore, in some embodiments, there are an additional two kernels that perform upsampling and convolution (again, horizontal and vertical). The second upsampling kernel may also perform image subtraction, as needed. Additionally, in some embodiments, multiple kernels processing the Laplacian pyramid layers may execute in parallel to one another. It should also be noted that alternative configurations may be applied. For example, in some embodiments each pyramid layer may be assigned more than two kernels. Similarly, in some embodiments, the parallelization of the individual kernels may be configured to optimize the overall processing of the image.

The device 210 includes one or more thread blocks 230 which represent the computation unit of the device. The term thread block refers to a group of threads that can cooperate via shared memory and synchronize their execution to coordinate memory accesses. For example, in FIG. 2, threads 240, 245 and 250 operate in thread block 230 and access shared memory 235. Depending on the parallel computing platform used, thread blocks may be organized in a grid structure. A computation or series of computations may then be mapped onto this grid. For example, in embodiments utilizing CUDA, computations may be mapped on one-, two-, or three-dimensional grids. Each grid contains multiple thread blocks, and each thread block contains multiple threads. For example, in FIG. 2, the thread blocks 230 are organized in a two dimensional grid structure with m+1 rows and n+1 columns. Generally, threads in different thread blocks of the same grid cannot communicate or synchronize with each other. However, thread blocks in the same grid can run on the same multiprocessor within the GPU at the same time. The number of threads in each thread block may be limited by hardware or software constraints.

Continuing with reference to FIG. 2, registers 255, 260, and 265 represent the fast memory available to thread block 230. Each register is only accessible by a single thread. Thus, for example, register 255 may only be accessed by thread 240. Conversely, shared memory is allocated per thread block, so all threads in the block have access to the same shared memory. Thus, shared memory 235 is designed to be accessed, in parallel, by each thread 240, 245, and 250 in thread block 230. Threads can access data in shared memory 235 loaded from device memory 220 by other threads within the same thread block (e.g., thread block 230). The device memory 220 is accessed by all blocks of the grid and may be implemented using, for example, Dynamic Random-Access Memory (DRAM).

Each thread can have one or more levels of memory access. For example, in the memory architecture 200 of FIG. 2, each thread may have three levels of memory access. First, each thread 240, 245, 250, can read and write to its corresponding registers 255, 260, and 265. Registers provide the fastest memory access to threads because there are no synchronization issues and the register is generally located close to a multiprocessor executing the thread. Second, each thread 240, 245, 250 in thread block 230, may read and write data to the shared memory 235 corresponding to that block 230. Generally, the time required for a thread to access shared memory exceeds that of register access due to the need to synchronize access among all the threads in the thread block. However, like the registers in the thread block, the shared memory is typically located close to the multiprocessor executing the threads. The third level of memory access allows all threads on the device 210 to read and/or write to the device memory. Device memory requires the longest time to access because access must be synchronized across the thread blocks operating on the device. Thus, in some embodiments, the calculation of the individual pyramid layers is coded such that it primarily utilizes registers and shared memory and only utilizes device memory as necessary to move data in and out of a thread block.

Using the techniques described herein, a parallel computing platform and programming model (including components such as the memory architecture 200 illustrated in FIG. 2) may be applied to perform fast computation of a Laplacian pyramid in image processing applications. For example, in some embodiments, kernels executable on a parallel computing platform are developed to perform operations related to calculation of individual layers of Laplacian and Gaussian pyramids. The techniques described herein are based, in part, on the observation that it is wasteful to compute the convolution of the whole image when it is about to be downsampled, since ¾ of the computed elements will be thrown away. A similar observation can be made about computing the convolution of the upsampled image, where ¾ of the elements are zeros. The time required to fetch the zeroes from global memory can be substantial and adds an unnecessary increase in the overall processing time. In some manifestations of Laplacian pyramids, the ¾ of the computed elements in the upsampled images are not 0, but are equal to the original elements. This knowledge may also be applied to avoid accessing expensive global memory to fetch their values when computing the full convolution.

When computing individual pyramid layers, a single operation may be executed wherein the upsampling or downsampling are combined with low pass filtering into one step. For example, in some embodiments, each convolution involves a separable 5×5 Gaussian filter, which may be split into the horizontal and vertical filters of the sizes 5×1 and 1×5. Then, each combined operation will include two passes through the image (horizontal and vertical), each including both the elements of the 1-D convolution and upsampling or downsampling in the direction of the pass through the image.

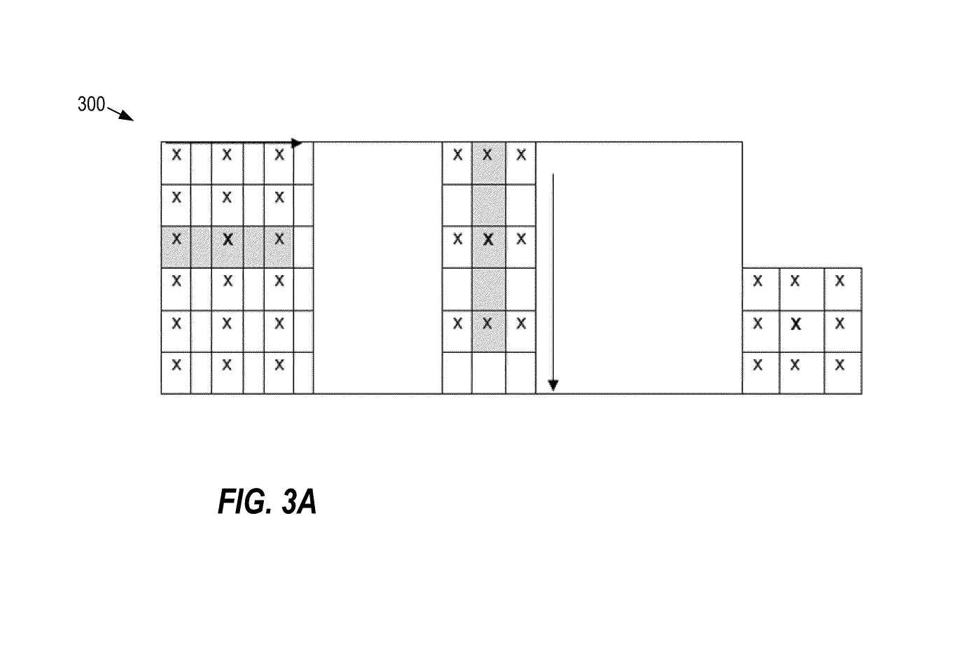

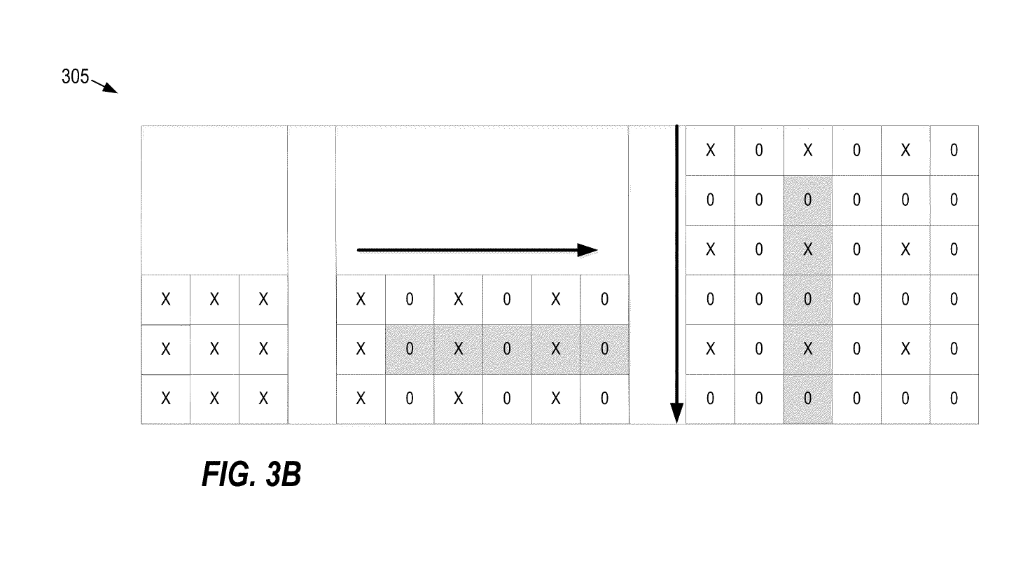

FIG. 3A provides an example of downsampling processing 300, according to some embodiments of the present invention. In this example, the convolution computation is limited to elements that will survive the transition to the next downsampled image. In some embodiments, during the horizontal pass, the convolution of only even columns is computed, since the odd columns will be thrown away during downsampling. The convolved and downsampled result may be written into an intermediate device buffer. During the second, vertical pass, convolution of only even rows may be computed, since the odd ones will not survive downsampling. Thus, in the 6×6 image, 18 horizontal convolutions and 9 vertical ones are computed rather than 36.

FIG. 3B provides an example of upsampling processing 305, according to some embodiments of the present invention. In this example, the convolution is computed for all elements displayed in the picture. However, only the nonzero contributions need to be summed during the operation. When coding the convolution with upsampling, the convolution may be written explicitly, distinguishing two cases: the first with convolution center being a zero cell (as shown in FIG. 3B) and the second with convolution center being a nonzero cell. When writing the expression for convolution, contributions from the terms that correspond to zero cells may be omitted.

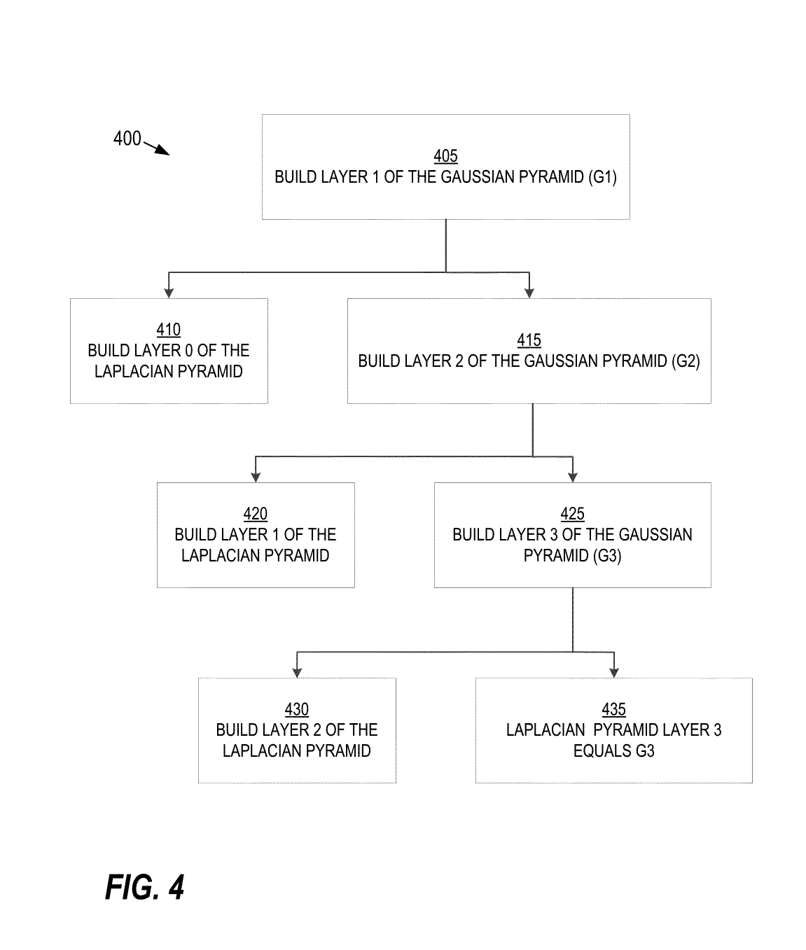

FIG. 4 provides an illustration of a method 400 building a Laplacian pyramid with 4 layers, according to some embodiments of the present invention. At step 405, the first layer of the Gaussian pyramid G1 is constructed based on a low-pass filtered and down-sampled original image. At step 410, layer L0 of the Laplacian pyramid is constructed by upsampling and smoothing pyramid layer G1 and subtracting the result from the original image. At step 415, G1 is down-sampled and convolved with a Gaussian filter to build the second layer of the Gaussian pyramid G2. Steps 410 and 415 may occur in any order. Additionally, in some embodiments, parallel processing techniques may be utilized to perform steps 410 and 415 in parallel.

Continuing with reference to FIG. 4, at step 420, layer L1 of the Laplacian pyramid is built by upsampling and smoothing G2, then subtracting the result from G1. At step 425, G2 is downsampled and convolved with the Gaussian filter to build the third layer of the Gaussian pyramid G3. As with steps 410 and 415 discussed above, steps 420 and 425 may be performed in any order and may, in some embodiments, be performed in parallel. Next, at step 430, layer L2 of the Laplacian pyramid is built by upsampling and smoothing G3, then subtracting the result from G2. Finally, as shown in step 435, the third layer of the Laplacian pyramid L3 is equal to G3.

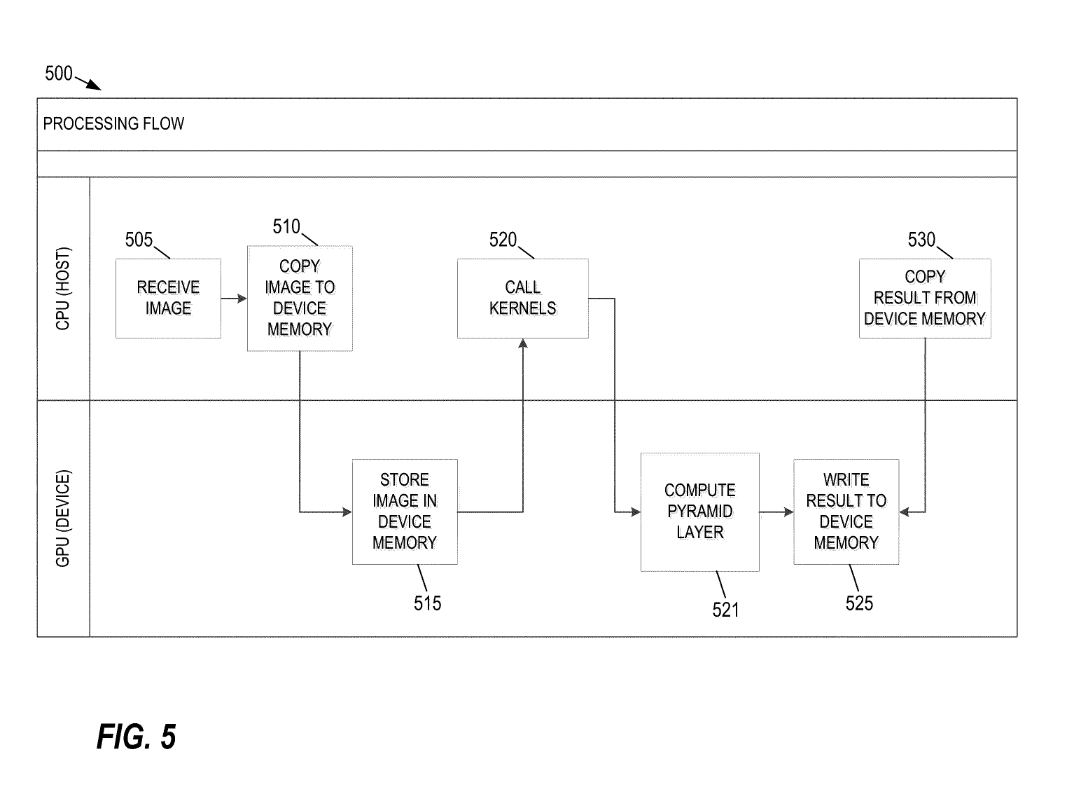

FIG. 5 provides a flowchart 500 illustrating how images may be processed by an image processing computer utilizing a parallel computing platform, according to some embodiments of the present invention. At 505, the host computing unit (e.g., host 205) receives an image, for example, via an imaging device and stores it in memory (e.g., host memory 225). Next, at 510, the host computing copies the image from host memory to device memory at the graphical processing device (e.g., device 210) where it is stored at 515. This copying may be performed, for example, by calling a memory copy function provided by an API associated with the parallel computing platform.

Continuing with reference to FIG. 5, at 520, the host computing calls device kernels configured to perform operations related to calculation of image pyramid layers using many threads simultaneously on the graphical processing device. For example, in some embodiments, these kernels may include a first kernel configured to calculate a Gaussian pyramid layer and a second kernel configured to calculate a respective Laplacian pyramid layer. In some embodiments, for example where graphical processing device supports CUDA, each respective kernel may be called by specifying the name of the kernel and an execution configuration. The execution configuration may define, for example, the number of threads in each thread block and the number of thread blocks to use when executing the kernel on the device. Calling the kernels result in the software being executed on the device 510 to compute one or more operations related to calculation of the pyramid layer. One example of the operations that may be performed at 521 is described above with respect to FIG. 3. After a pyramid layer has been calculated, the graphical processing device writes the result to graphical processing device memory at step 525. Finally, at 530, the host device copies the result from graphical processing device memory to memory on the host device. Each individual layer of the pyramid may be calculated by iteratively performing steps 520 through 525 until all the pyramid layers have been calculated. Alternatively, one or more additional kernels may be added which manage processing of the individual layers, thus eliminating the need to communicate between the host computing unit and the graphical processing device during construction of the pyramid.

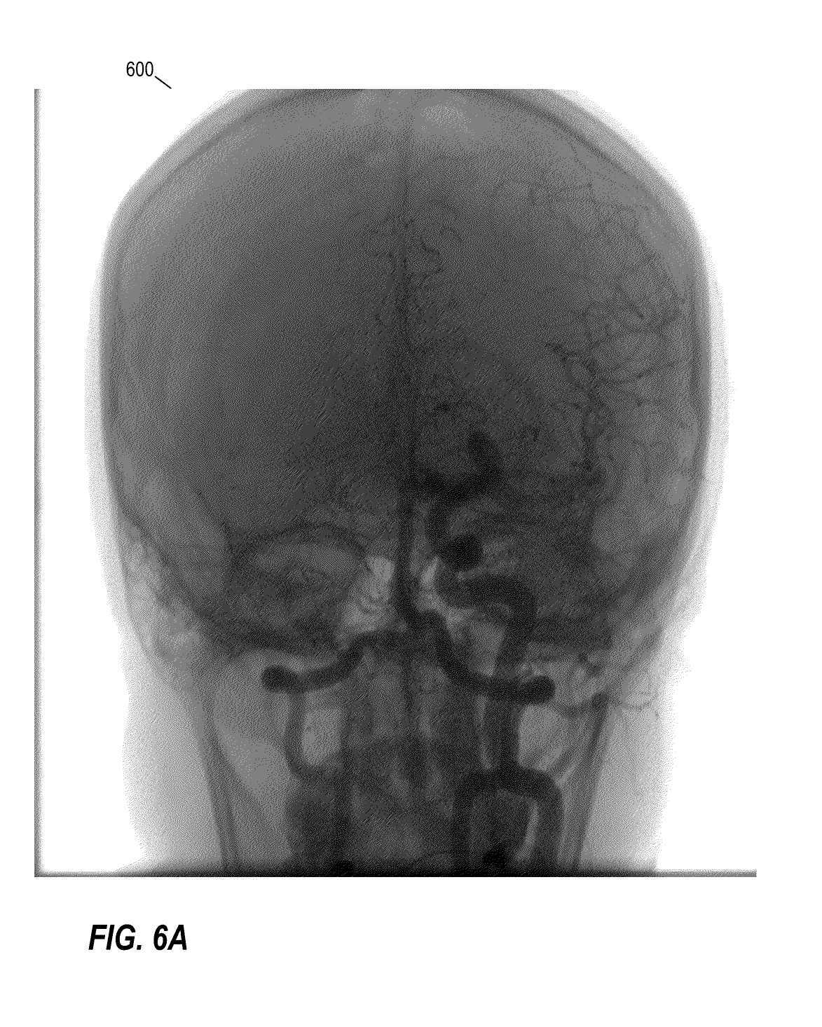

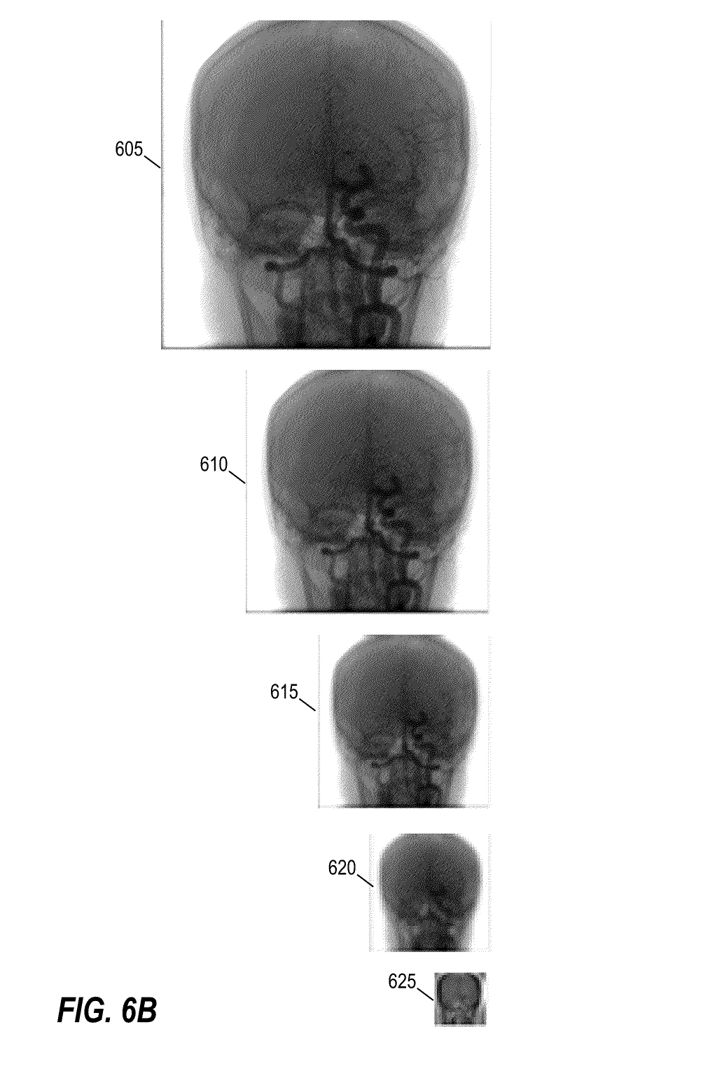

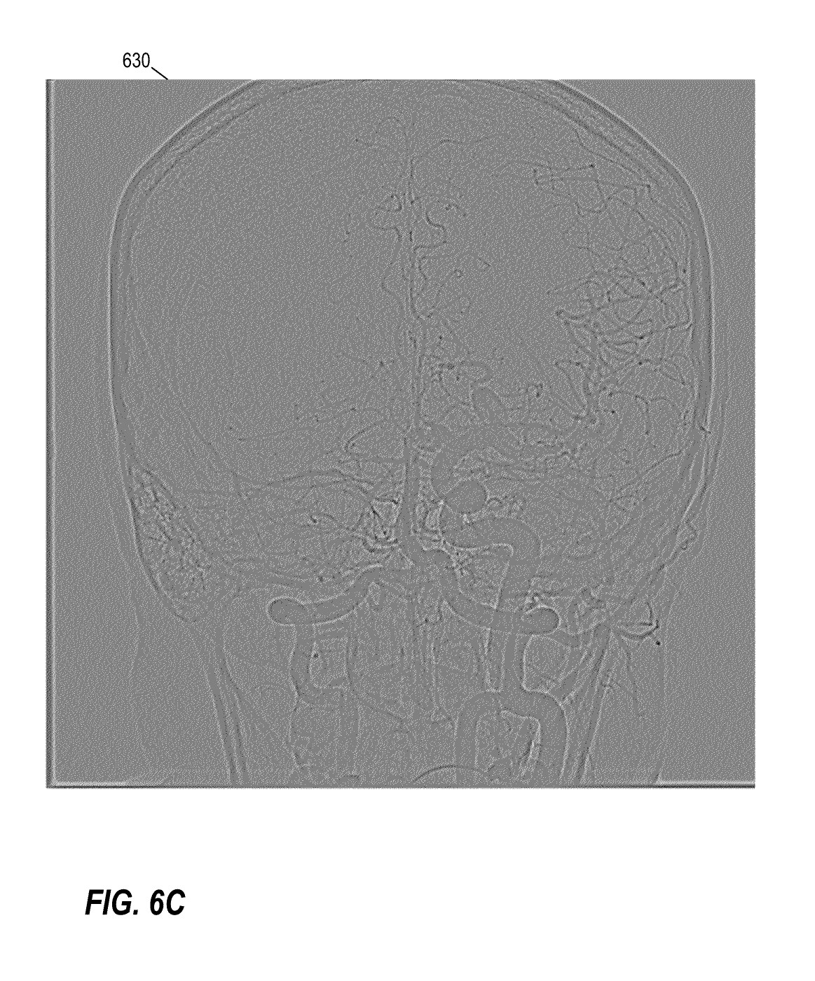

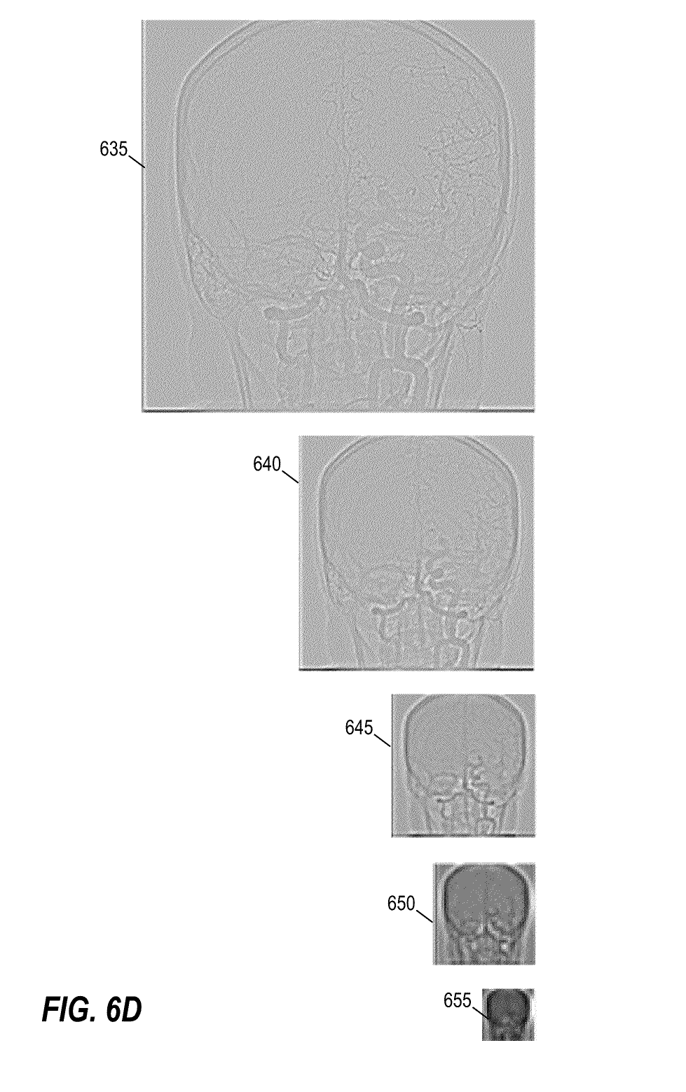

FIG. 6A shows an original image 600 that may be acquired by an imaging device, according to some embodiments of the present invention. FIG. 6B shows the results of application of a Gaussian pyramid calculation process to the original image 600, according to some embodiments of the present invention. Image 605 shows the results for layer 1 of the pyramid, with 360×360 pixels. Images 610 and 615 show the results for layers 2 and 3, at 180×180 and 90×90 pixels, respectively. Finally, images 620 and 625 show the results for layers 4 and 5, at 45×45 and 23×23 pixels, respectively.

FIGS. 6C and 6D show the results of calculation of the Laplacian pyramid corresponding to the original image 600 at different stages, according to some embodiments of the present invention. FIG. 6C shows an image 630 depicting layer 0 of the Laplacian pyramid, with pixel values of 720×720. The image depicted in FIG. 6D show the results for layer 1 through layer 5. Specifically, image 635 shows the results for layer 1 of the Laplacian pyramid, with 360×360 pixels. Images 640 and 645 show the results for layers 2 and 3, at 180×180 and 90×90 pixels, respectively. Finally, images 650 and 655 show the results for layers 4 and 5, at 45×45 and 23×23 pixels, respectively.

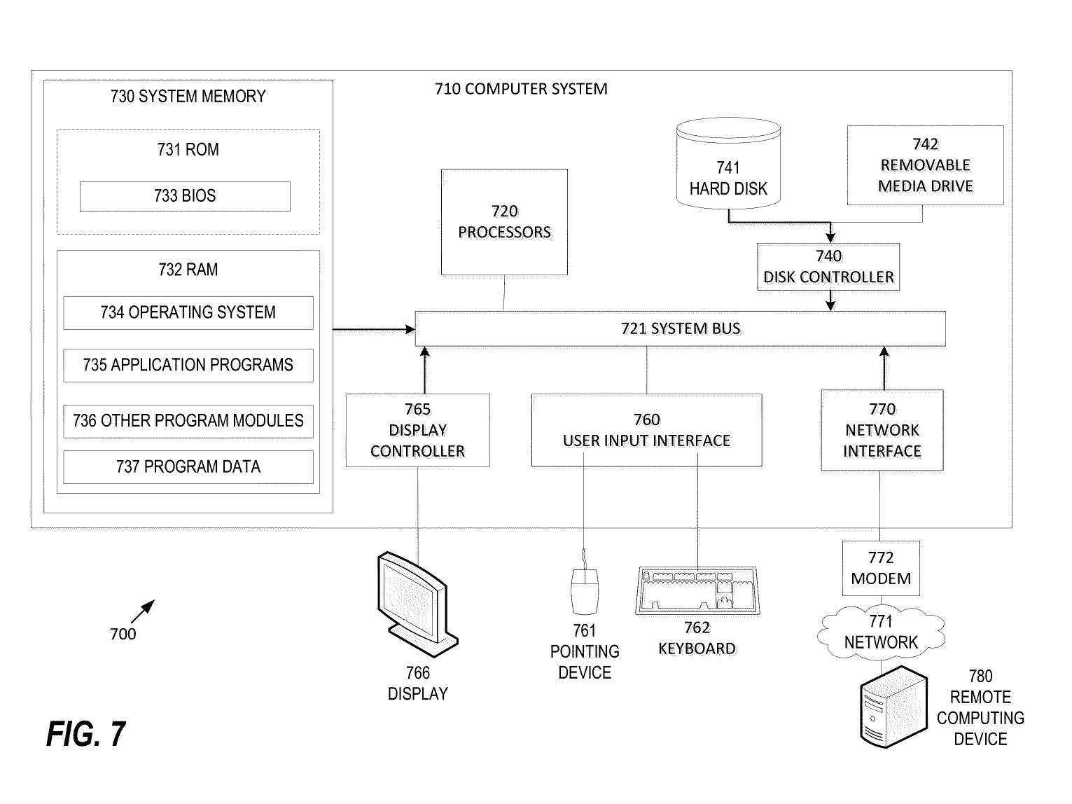

FIG. 7 illustrates an example of a computing environment 700 within which embodiments of the invention may be implemented. Computing environment 700 may include computer system 710, which is one example of a general purpose computing system upon which embodiments of the invention may be implemented. Computers and computing environments, such as computer system 710 and computing environment 700, are known to those of skill in the art and thus are described briefly here.

As shown in FIG. 7, the computer system 710 may include a communication mechanism such as a bus 721 or other communication mechanism for communicating information within the computer system 710. The computer system 710 further includes one or more processors 720 coupled with the bus 721 for processing the information. The processors 720 may include one or more CPUs, GPUs, or any other processor known in the art.

The computer system 710 also includes a system memory 730 coupled to the bus 721 for storing information and instructions to be executed by processors 720. The system memory 730 may include computer readable storage media in the form of volatile and/or nonvolatile memory, such as read only memory (ROM) 731 and/or random access memory (RAM) 732. The system memory RAM 732 may include other dynamic storage device(s) (e.g., dynamic RAM, static RAM, and synchronous DRAM). The system memory ROM 731 may include other static storage device(s) (e.g., programmable ROM, erasable PROM, and electrically erasable PROM). In addition, the system memory 730 may be used for storing temporary variables or other intermediate information during the execution of instructions by the processors 720. A basic input/output system 733 (BIOS) containing the basic routines that help to transfer information between elements within computer system 710, such as during start-up, may be stored in ROM 731. RAM 732 may contain data and/or program modules that are immediately accessible to and/or presently being operated on by the processors 720. System memory 730 may additionally include, for example, operating system 734, application programs 735, other program modules 736 and program data 737.

The computer system 710 also includes a disk controller 740 coupled to the bus 721 to control one or more storage devices for storing information and instructions, such as a magnetic hard disk 741 and a removable media drive 742 (e.g., floppy disk drive, compact disc drive, tape drive, and/or solid state drive). The storage devices may be added to the computer system 710 using an appropriate device interface (e.g., a small computer system interface (SCSI), integrated device electronics (IDE), Universal Serial Bus (USB), or FireWire).

The computer system 710 may also include a display controller 765 coupled to the bus 721 to control a monitor or display 766, such as a cathode ray tube (CRT) or liquid crystal display (LCD), for displaying information to a computer user. The computer system includes an input interface 760 and one or more input devices, such as a keyboard 762 and a pointing device 761, for interacting with a computer user and providing information to the processor 720. The pointing device 761, for example, may be a mouse, a trackball, or a pointing stick for communicating direction information and command selections to the processor 720 and for controlling cursor movement on the display 766. The display 766 may provide a touch screen interface which allows input to supplement or replace the communication of direction information and command selections by the pointing device 761.

The computer system 710 may perform a portion or all of the processing steps of embodiments of the invention in response to the processors 720 executing one or more sequences of one or more instructions contained in a memory, such as the system memory 730. Such instructions may be read into the system memory 730 from another computer readable medium, such as a hard disk 741 or a removable media drive 742. The hard disk 741 may contain one or more datastores and data files used by embodiments of the present invention. Datastore contents and data files may be encrypted to improve security. The processors 720 may also be employed in a multi-processing arrangement to execute the one or more sequences of instructions contained in system memory 730. In alternative embodiments, hard-wired circuitry may be used in place of or in combination with software instructions. Thus, embodiments are not limited to any specific combination of hardware circuitry and software.

As stated above, the computer system 710 may include at least one computer readable medium or memory for holding instructions programmed according embodiments of the invention and for containing data structures, tables, records, or other data described herein. The term “computer readable medium” as used herein refers to any medium that participates in providing instructions to the processor 720 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 741 or removable media drive 742. Non-limiting examples of volatile media include dynamic memory, such as system memory 730. Non-limiting examples of transmission media include coaxial cables, copper wire, and fiber optics, including the wires that make up the bus 721. Transmission media may also take the form of acoustic or light waves, such as those generated during radio wave and infrared data communications.

The computing environment 700 may further include the computer system 710 operating in a networked environment using logical connections to one or more remote computers, such as remote computing device 780. Remote computing device 780 may be a personal computer (laptop or desktop), a mobile device, a server, a router, a network PC, a peer device or other common network node, and typically includes many or all of the elements described above relative to computer system 710. When used in a networking environment, computer system 710 may include modem 772 for establishing communications over a network 771, such as the Internet. Modem 772 may be connected to bus 721 via user network interface 770, or via another appropriate mechanism.

Network 771 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 710 and other computers (e.g., remote computing device 780). The network 771 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 771.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A computer-implemented method for calculating a Laplacian pyramid in an image processing system comprising a parallel computing platform, the method comprising:
constructing a first layer of a Gaussian pyramid based on an original image;
constructing a plurality of Laplacian pyramid layers using a plurality of device kernels executing on a graphical processing device included in the parallel computing platform, wherein each respective Laplacian pyramid layer is constructed by a process comprising:
using one or more first device kernels to calculate a Gaussian pyramid layer based on a immediately preceding Gaussian pyramid layer; and
using one or more second device kernels to calculate the respective Laplacian pyramid layer based on the immediately preceding Gaussian pyramid layer in parallel with calculation of the Gaussian pyramid layer.

2. The method of claim 1, wherein each respective Gaussian pyramid layer is calculated using a single operation on a respective computation unit, the single operation combining:
upsampling the immediately preceding Gaussian pyramid layer to yield a upsampled layer, and
convolving the upsampled layer with a Gaussian filter to yield the Gaussian pyramid layer.

3. The method of claim 2, wherein the single operation further comprises downsampling the Gaussian pyramid layer.

4. The method of claim 2, wherein convolving the upsampled layer with the Gaussian filter to yield the Gaussian pyramid layer comprises:
computing a plurality of horizontal convolutions using a horizontal filter and the upsampled layer; and
computing a plurality of vertical convolutions using a vertical filter and the upsampled layer.

5. The method of claim 4, wherein the plurality of horizontal convolutions and the plurality of vertical convolutions are computed in separate device kernels included in the one or more first device kernels.

6. The method of claim 1, wherein each respective Laplacian pyramid layer is calculated using a single operation on a respective computation unit, the single operation comprising:
upsampling the immediately preceding Gaussian pyramid layer to yield an upsampled layer;
smoothing the upsampled layer to yield a smoothed upsampled layer; and
subtracting the smoothed upsampled layer from the original image or from a corresponding layer of the Gaussian pyramid to yield the respective Laplacian pyramid layer.

7. The method of claim 6, wherein smoothing the upsampled layer to yield the smoothed upsampled layer comprises:
computing a plurality of horizontal convolutions using a horizontal filter and the upsampled layer; and
computing a plurality of vertical convolutions using a vertical filter and the upsampled layer.

8. The method of claim 4, wherein the plurality of horizontal convolutions and the plurality of vertical convolutions are computed in separate device kernels included in the one or more second device kernels.

9. The method of claim 1, wherein two or more of the plurality of Laplacian pyramid layers are calculated in parallel using the parallel computing platform.

10. A computer-implemented method for calculating a Laplacian pyramid in an image processing system comprising a host computing unit and a graphical processing device, the method comprising:
copying an original image from a host memory at the host computing unit to a portion of device memory on the graphical processing device;
constructing a first layer of a Gaussian pyramid based on the original image;
executing a plurality of device kernels on the graphical processing device to calculate the Laplacian pyramid, wherein each respective layer in the Laplacian pyramid is calculated using a set of device kernels comprising:
one or more first kernels configured to calculate a Gaussian pyramid layer based on a immediately preceding Gaussian pyramid layer, and
one or more second kernels configured to calculate a respective Laplacian pyramid layer based on the immediately preceding Gaussian pyramid layer; and
copying the Laplacian pyramid from the portion of device memory on the graphical processing device to the host memory.

11. The method of claim 10, further comprising:
prior copying the original image to the portion of device memory, allocating the portion of device memory on the graphical processing device based on a size of the original image; and
after executing the plurality of device kernels, deallocating the portion of device memory.

12. The method of claim 10, wherein the set of device kernels executes in parallel on the graphical processing device.

13. The method of claim 10, wherein the first layer of the Gaussian pyramid is constructed at the graphical processing device using a third kernel configured to calculate the first layer of the Gaussian pyramid based on the original image.

14. The method of claim 10, wherein each respective first kernel is configured to calculate the Gaussian pyramid layer based on the immediately preceding Gaussian pyramid layer using a single operation combining:
upsampling the immediately preceding Gaussian pyramid layer to yield an upsampled layer;
convolving the upsampled layer with a Gaussian filter to yield the Gaussian pyramid layer; and
downsampling the Gaussian pyramid layer.

15. The method of claim 10, wherein each respective second kernel is configured to calculate the respective Laplacian pyramid layer using a single operation combining:
upsampling the immediately preceding Gaussian pyramid layer to yield an upsampled layer;
smoothing the upsampled layer to yield a smoothed upsampled layer; and
subtracting the smoothed upsampled layer from the original image to yield the respective Laplacian pyramid layer.

16. The method of claim 10, wherein each respective device kernel in the plurality of device kernels is executed independently by a distinct grid of thread blocks on the graphical processing device.

17. The method of claim 10, wherein two or more of the plurality of Laplacian pyramid layers are calculated in parallel using the parallel computing platform.

18. A system for calculating a Laplacian pyramid, the system comprising:
a processor configured to construct a first layer of a Gaussian pyramid based on an original image; and
a graphical processing device configured to execute a plurality of device kernels to calculate the Laplacian pyramid, wherein each respective Laplacian pyramid layer is calculated using a set of device kernels comprising:
one or more first device kernels configured to calculate a Gaussian pyramid layer based on a immediately preceding Gaussian pyramid layer, and
one or more second device kernels configured to calculate the respective Laplacian pyramid layer based on the immediately preceding Gaussian pyramid layer.

19. The system of claim 18, wherein each respective first device kernel is configured to calculate the Gaussian pyramid layer based on the immediately preceding Gaussian pyramid layer using a single operation combining:
upsampling the immediately preceding Gaussian pyramid layer to yield an upsampled layer;
convolving the upsampled layer with a Gaussian filter to yield the Gaussian pyramid layer; and
downsampling the Gaussian pyramid layer.

20. The system of claim 18, wherein each respective second device kernel is configured to the respective Laplacian pyramid layer using a single operation combining steps of:
upsampling the immediately preceding Gaussian pyramid layer to yield an upsampled layer;
smoothing the upsampled layer to yield a smoothed upsampled layer; and
subtracting the smoothed upsampled layer from the original image to yield the respective Laplacian pyramid layer.
